(19) United States
(12) Patent Application Publication
(10) Pub. No.: US 2008/0243438 A1
(43) Pub. Date: Oct. 2, 2008

(54) Maintenance information managing apparatus for component mounting machine

(75) Inventor: Tadamasa Okuda, Tokyo (JP)

Correspondence Address: DRINKER BIDDLE & REATH (DC), 1500 K STREET, N.W., SUITE 1100, WASHINGTON, DC, 20005-1209, US

(73) Assignee: JUKI CORPORATION

(21) Appl. No.: 11/902,859

(22) Filed: Sep. 26, 2007

(30) Foreign Application Priority Data
Sep. 27, 2006 (JP) P.2006-263391

(51) Int. Cl. G21C 17/00

(52) U.S. Cl. 702/184

(57) ABSTRACT

A maintenance information managing apparatus for a component mounting machine, the maintenance information managing apparatus including a device inspecting unit to which a device removed from the component mounting machine is attached and inspects the device, an identification reader which is attached to the device inspecting unit, and reads identification information from an identifying portion appended previously to the device when the device is attached to the device inspecting unit, and a receiver which receives information from the device inspecting unit. The information includes the identification information which identifies the device, and work information related to a work that is carried out in the device inspecting unit after an attachment of the device to the device inspecting unit until a removal of the device from the device inspecting unit.

The present invention claims priority from Japanese Patent Application No. 2006-263391, filed on Sep. 27, 2006, the entire content of which is incorporated herein by reference.

### BACKGROUND OF INVENTION

1. Field of the Invention

The present invention relates to a maintenance information managing apparatus for a component mounting machine. More particularly, the invention relates to a maintenance information managing apparatus which can relieve a burden of a work for acquiring maintenance information related to a device of the component mounting machine, thereby preventing a working error and enhancing an efficiency of a management of the maintenance information.

2. Description of the Related Art

In a component mounting machine for mounting an electronic component (which will be hereinafter referred to as a component) on a printed circuit board, generally, the type and number of components to be mounted are considerably increased in accordance with an enhancement in a function of an electronic circuit and a variation in market needs.

For this reason, a feeder for feeding a component to the component mounting machine (a tape feeder or a bulk feeder or the like) is provided in several tens of lines or more in some cases, and various sucking nozzles for sucking a component from the feeder and mounting the component on a printed circuit board are also provided on the component mounting machine so as to correspond to the type of the component.

Moreover, the feeder needs to be maintained periodically in order to ensure a reliability of a feeding operation. For example, a feeder having a low rate of sucking a component needs to be adjusted in relation to a component sucking position.

In a case in which the feeder is adjusted by using a feeder adjusting jig and if an operator wishes to manage information about the adjusted work as a history, information about works for individual feeders have conventionally been recorded, stored and managed in a computer or a memorandum or the like by a manual operation.

For example, JP-A-2005-244175 discloses a technique for reading a bar code appended to a feeder through a portable terminal, and inputting location data required for a maintenance and management and an suction rate read from a control display of a component mounting machine through a key by a manual operation.

In a conventional method of registering and managing maintenance information related to a feeder, however, there is a problem in that a working burden of an operator is increased when recording the maintenance information in a case in which the number of feeders to be adjusted is greatly increased.

Moreover, the input or description is carried out by the manual operation. Therefore, there is a problem in that an input error is made or the memorandum is missing.

In the technique disclosed in JP-A-2005-244175, furthermore, it is possible to read identification information of the feeder through a portable terminal and it is necessary to input data such as other location data through a key by a manual operation. Furthermore, a portable terminal is utilized for reading the identifying portion. For this reason, it is necessary to move the portable terminal by hands to a portion where the identifying portion is appended, and to manually input the data of a maintenance work in a feeder repairing section to the portable terminal. Thus, a complete automation linked to the work cannot be obtained.

### SUMMARY OF INVENTION

It is an object of the invention to relieve a burden of a work when acquiring maintenance information, to prevent a working error and to enhance an efficiency of a management of the maintenance information.

One or more embodiments of the invention provide a maintenance information managing apparatus for a component mounting machine, the maintenance information managing apparatus including a device inspecting unit to which a device removed from the component mounting machine is attached and inspects the device, an identification reader which is attached to the device inspecting unit, and reads identification information from an identifying portion appended previously to the device when the device is attached to the device inspecting unit, and a receiver which receives information from the device inspecting unit. The information includes the identification information which identifies the device, and work information related to a work that is carried out in the device inspecting unit after an attachment of the device to the device inspecting unit until a removal of the device from the device inspecting unit.

The identifying portion may be an RFID tag or a bar code.

The device may be a feeder which feeds a component to a component mounting machine.

According to one or more embodiment of the invention, when attaching the device to the device inspecting unit connected to a network, it is possible to read the identifying portion appended to the device and to automatically receive information about a work in the device inspecting unit. Therefore, it is possible to relieve the burden of the work when acquiring maintenance information about the component mounting machine, to prevent a working error and to enhance an efficiency of the management of the maintenance information.

In a case in which the identifying portion is an RFID tag or a bar code, it is possible to acquire the identification information of the device even if the recognizing reader is not always disposed in an exact position in non-contact.

In a case in which a device to be inspected is a feeder, it is possible to relieve the burden of a work when maintaining apparatuses to be used in a component mounting machine, to prevent a working error and to enhance an efficiency of a management of the maintenance information even if the number and type of the device is large.

### BRIEF DESCRIPTION OF THE DRAWINGS

FIG. 1 is a plan view showing a component mounting machine according to an embodiment of the invention,

FIG. 2 is a schematic view showing a maintenance information managing apparatus according to a first embodiment of the invention,

FIG. 3 is a perspective view showing a feeder adjusting jig according to an embodiment of the invention,

FIG. 4 is a sequence diagram for explaining an operation in the maintenance information managing apparatus according to the first embodiment,

FIG. 5 is a perspective view showing a state in which a feeder is attached to the feeder adjusting jig,

FIG. 6 is a schematic view showing a maintenance information managing apparatus according to a second embodiment of the invention, and

FIG. 7 is a sequence diagram for explaining an operation in the maintenance information managing apparatus according to the second embodiment.

### DETAILED DESCRIPTION

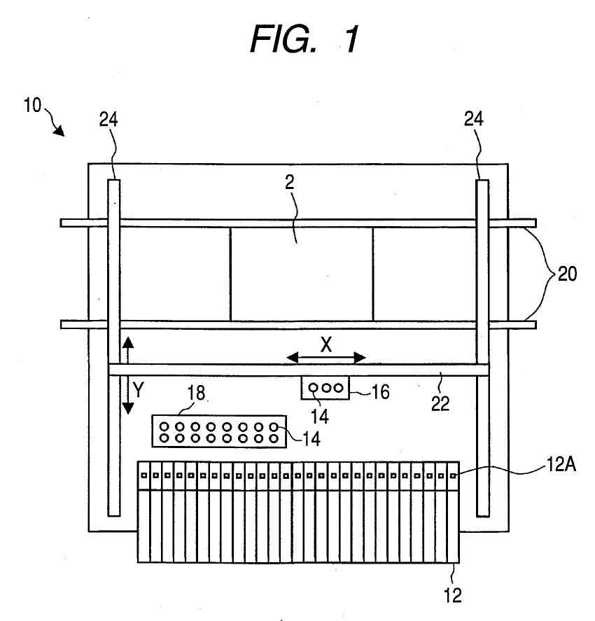

FIG. 1 is a plan view showing a component mounting machine according to a first embodiment of the invention.

As shown in FIG. 1, a component mounting machine 10 includes a plurality of feeders 12 which is arranged side by side on a front surface thereof and serves to feed a component to the component mounting machine 10, an sucking nozzle 14 for sucking the component fed from a component sucking position 12A of the feeder 12, a mounting head 16 including the sucking nozzle 14 and serving to mount the component on a printed circuit board 2, a nozzle holder 18 for stocking a various types of sucking nozzles 14 so as to exchange the sucking nozzle 14 to be used every component type, a substrate delivering device 20 for delivering the printed circuit board 2, and an X-axis gantry 22 and a Y-axis gantry 24 which serve to move the mounting head 16 in X-axis and Y-axis directions.

Next, a maintenance information managing apparatus of the component mounting machine 10 according to an embodiment of the invention will be described with reference to the drawings.

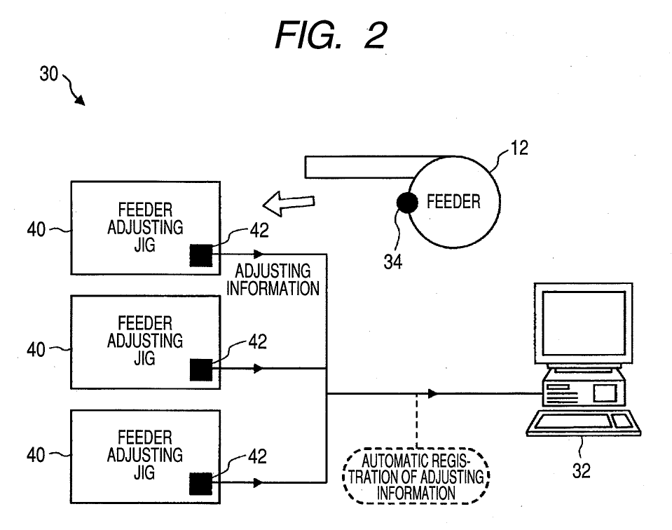

As shown in FIG. 2, a maintenance information managing apparatus 30 includes the feeder 12 which is a device to be inspected, a feeder adjusting jig 40 to be a device inspecting unit for attaching the feeder 12 to carry out an inspection, and a maintenance information managing computer (which will be hereinafter referred to as a maintenance computer) 32 for receiving and managing information transferred from the feeder adjusting jigs 40. In each of the feeder adjusting jigs 40, different operators usually carry out the work.

As an identifying portion, an RFID (Radio Frequency ID) tag (which will also be referred to as an IC tag) 34 is appended to the feeder 12, and the feeder 12 and the RFID tag 34 can be related to each other based on a database of the maintenance computer 32.

The feeder adjusting jig 40 includes an RFID reader 42 for reading the information of the RFID tag 34. When the feeder 12 is attached, the information from the RFID tag 34 which is previously appended to the feeder 12 can be read.

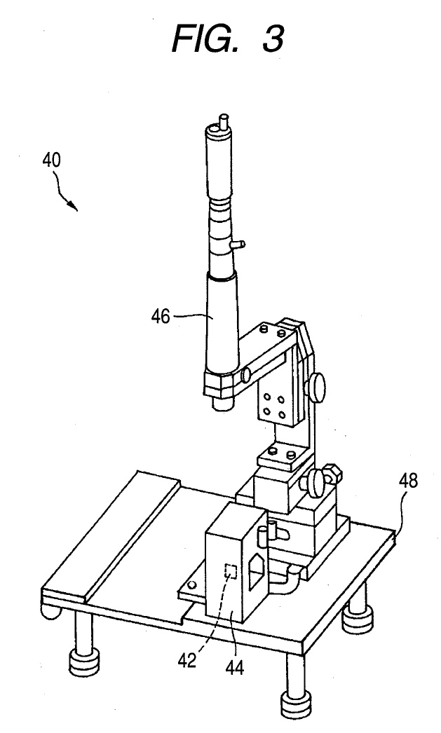

As shown in FIG. 3, the feeder adjusting jig 40 includes a reader mounting portion 44 provided with the RFID reader 42, a camera 46 for capturing an image of the component sucking position 12A of the feeder 12, a horizontal support table 48 for supporting them, and a monitor (not shown) for displaying an image of the component sucking position 12A which is picked up by the camera 46. The feeder 12 is attached and fixed to a predetermined position. It is possible to inspect and adjust the feeder 12 while watching an image of the component sucking position 12A of the feeder 12 which is displaying.

Moreover, the reader mounting portion 44 includes identification information which identifies the feeder adjusting jig 40 itself, and the identification information and the feeder adjusting jig 40 can be related to each other based on the database of the maintenance computer 32.

Furthermore, the feeder adjusting jig 40 and the maintenance computer 32 can be connected to each other through a network, and work information in each feeder adjusting jig 40 can be registered automatically.

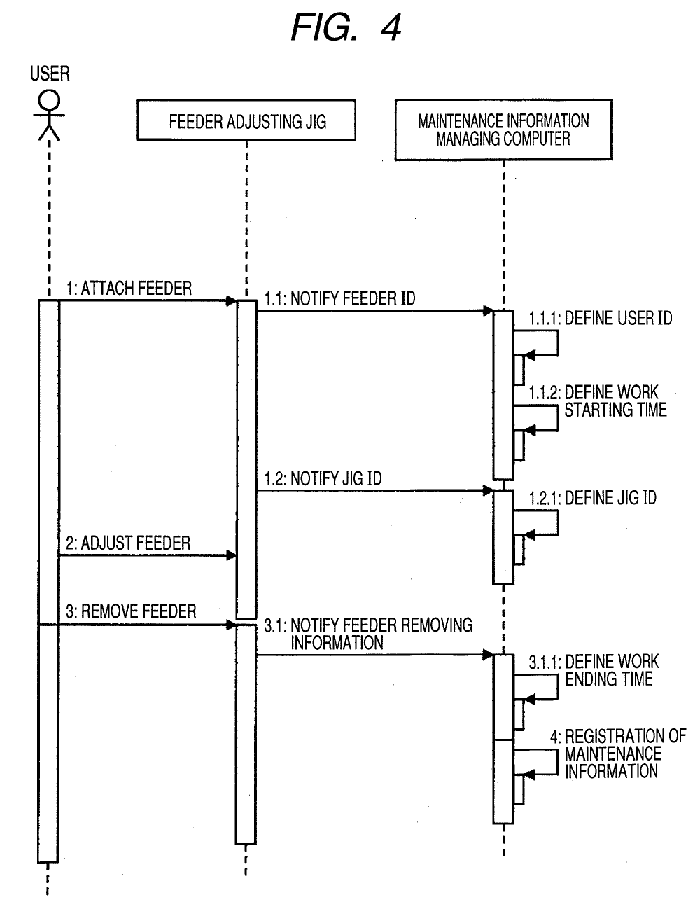

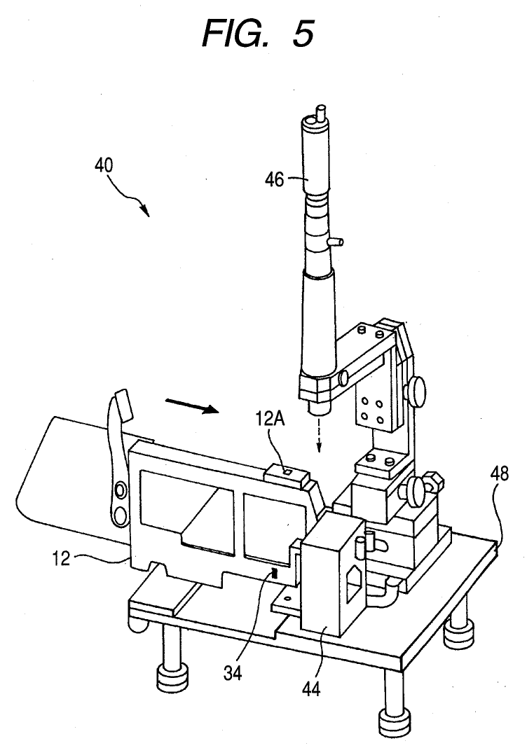

Next, an operation in the maintenance information managing apparatus 30 will be described with reference to a sequence diagram of FIG. 4 and a perspective view showing a state of a feeder attachment in FIG. 5.

First of all, an operator of the feeder 12 (which will be hereinafter referred to as a user) attaches the feeder at a sequence number 1 in FIG. 4. Therefore, the feeder 12 to be inspected is removed from the component mounting machine 10, and is attached to the feeder adjusting jig 40 as shown in FIG. 5.

When the feeder 12 is attached into a predetermined position of the feeder adjusting jig 40, the component sucking position 12A of the feeder 12 is positioned below the camera 46 so that a component in the component sucking position 12A is displayed onto the monitor. The RFID tag 34 appended to the feeder 12 is placed at a position at which it can be read by the RFID reader 42 of the reader mounting portion 44.

The feeder adjusting jig 40 periodically and continuously scans whether the feeder 12 for a maintenance is attached or not through the RFID reader 42. When the feeder 12 is attached into the predetermined position as described above, therefore, it is detected and feeder ID information of the RFID tag 34 is given to the maintenance computer 32 at a sequence number of 1.1.

In a case in which a user carries out maintenance of each feeder 12, thus, feeder ID information is automatically given to the maintenance computer 32 when the feeder 12 is attached to the feeder adjusting jig 40. By the maintenance computer 32, feeder ID information of the feeder 12 to be a maintenance target is defined at a sequence number of 1. 1. 1, and a work starting time is defined as work information of the feeder adjusting jig 40 at a sequence number of 1. 1. 2.

Moreover, jig ID information of the feeder adjusting jig 40 on which the maintenance is carried out is also given to a maintenance information management system at a sequence number of 1. 2, and jig ID information of the feeder adjusting jig 40 is also defined and stored by the maintenance computer 32 at a sequence number of 1. 2. 1.

Next, the user inspects the feeder 12 at a sequence number of 2. If the adjustment is required, the feeder 12 is adjusted. The result is also given as working contents (the presence of the adjustment in the feeder adjusting jig 40) to the maintenance computer 32, which is not shown in FIG. 4.

When the user ends a predetermined maintenance work (a work for adjusting a component sucking position) and removes the feeder 12 from the feeder adjusting jig 40 at a sequence number of 3, information about the removal of the feeder 12 is given to the maintenance computer 32 as the end of the maintenance at a sequence number of 3.1. Next, a work ending time is defined based on the feeder removing information at a sequence number of 3.1.1, and is registered as maintenance history information of the feeder 12 in the database of the maintenance computer 32 at a sequence number of 4.

According to the embodiment, it is possible to automatically register work information such as a work starting time, a work ending time, information of jig ID which is used, and the contents of the work (the presence of the adjustment in the feeder adjusting jig 40) in each feeder adjusting jig 40 every feeder 12.

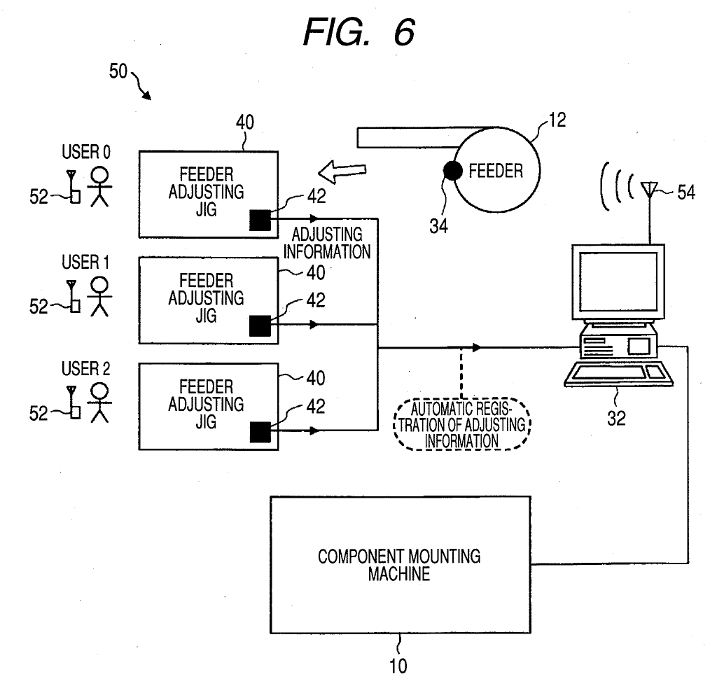

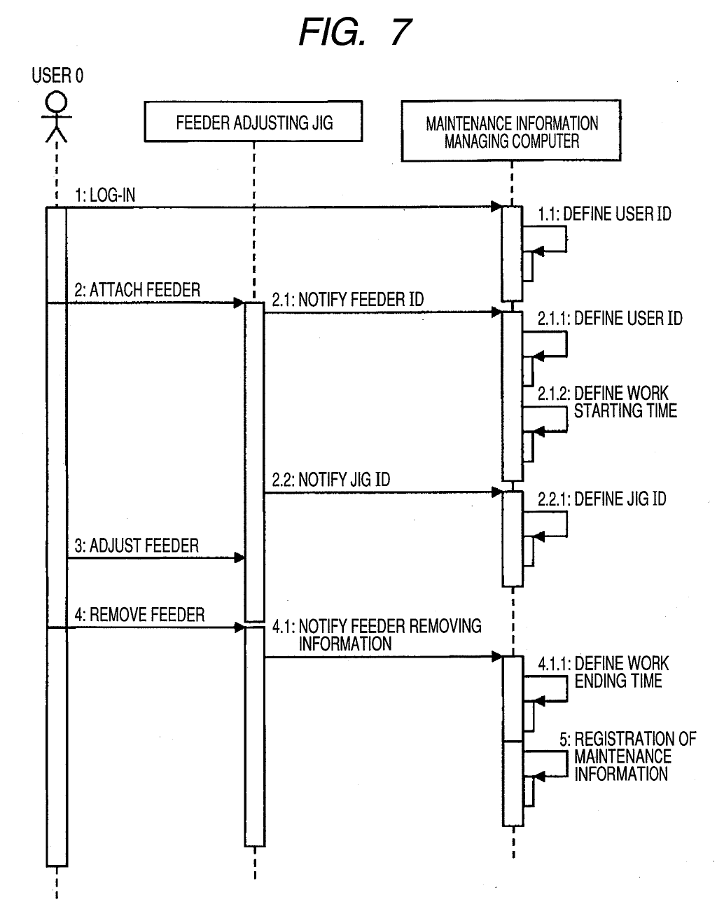

Next, a second embodiment will be described with reference to FIGS. 6 and 7.

As shown in FIG. 6, a maintenance information managing apparatus 50 according to the second embodiment is different from the first embodiment in that a maintenance computer 32 is connected to a component mounting machine 10, and that the maintenance information managing apparatus 50 further includes a portable receiving terminal 52 which is possessed by each user, and an antenna 54 for transmitting information from the maintenance computer 32 to the portable receiving terminal 52.

For example, as shown in FIG. 7, a user 0 carries out log-into the maintenance computer 32 before the start of the work at a sequence number of 1, and previously designates which feeder adjusting jig 40 is to be used. At a sequence number of 1.1, a user ID is defined and a user ID of the user 0 is automatically registered.

A subsequent sequence is similar to that in the first embodiment. However, differently from the first embodiment, in order to prevent the user from erroneously starting to adjust a feeder 12 which does not need to be maintained, an alarm is displayed on the maintenance computer 32 or a notice is given to the portable terminal 52 held by each user in the event that such a feeder 12 is attached to the feeder adjusting jig 40 at a sequence number of 2.

Information which sets that the maintenance is unnecessary is stored in the database of the maintenance computer 32. Such information in the database may be a time base information, a suction number base information or a suction rate base information. A time base means that an unnecessary alarm is given in a case in which a maintenance is executed again when an elapsed time from a latest maintenance is equal to or shorter than a predetermined time which is set by the user. A suction number base means that an unnecessary alarm is given in a case in which the maintenance is executed again when the number of suctions after the latest maintenance, that is, the number of suctions carried out by an sucking nozzle 14 is equal to or smaller than a predetermined number of suctions which is set by the user. A suction rate base means that an unnecessary alarm is given in a case in which the maintenance is executed again when a suction rate obtained after the latest maintenance, that is, a rate of not failing an suction of the sucking nozzle 14 from a component sucking position 12A is higher than a predetermined suction rate set by the user. The suction number base information and the suction rate base information are information collected from the component mounting machine 10. According to second the embodiment, it is possible to feed back the presence of a necessity of the maintenance to an operator, and it is not necessary to carry out an inspecting work for the feeder 12 which is not required to be maintained. Consequently, it is possible to enhance an efficiency of the work.

Moreover, the operator can freely set a definition of necessary information, such as a suction number or a suction rate, for deciding whether a maintenance such as an suction number or an suction rate is required or not. Therefore, it is possible to check whether the maintenance is required or not in various respects in accordance with to a system to be applied. Thus, the maintenance can be carried out without a waste.

It is possible to replace RFID with a bar code or a two-dimensional code, and to register maintenance information by using a barcode reader or a two-dimensional code reader.

Furthermore, information on an inspection work of a device can be automatically registered as in the first and second embodiments so that a burden of the work can be relieved to enhance an efficiency.

What is claimed is:

1. A maintenance information managing apparatus for a component mounting machine, the maintenance information managing apparatus comprising:
a device inspecting unit to which a device removed from the component mounting machine is attached, and inspects the device;
an identification reader which is attached to the device inspecting unit, and reads identification information from an identifying portion appended previously to the device when the device is attached to the device inspecting unit; and
a receiver which receives information from the device inspecting unit,
wherein the information comprises:
the identification information which identifies the device; and
work information related to a work that is carried out in the device inspecting unit after an attachment of the device to the device inspecting unit until a removal of the device from the device inspecting unit.

2. The maintenance information managing apparatus according to claim 1,
wherein the identifying portion includes an RFID tag.

3. The maintenance information managing apparatus according to claim 1,
wherein the identifying portion includes a bar code.

4. The maintenance information managing apparatus according to claim 1,
wherein the identifying portion includes an RFID tag or a two-dimensional code.

5. The maintenance information managing apparatus according to claim 1,
wherein the device includes a feeder which feeds a component to the component mounting machine.

6. The maintenance information managing apparatus according to claim 2,
wherein the device includes a feeder which feeds a component to the component mounting machine.

7. The maintenance information managing apparatus according to claim 3,
wherein the device includes a feeder which feeds a component to the component mounting machine.

8. The maintenance information managing apparatus according to claim 1,
wherein the information further comprises identification information which identifies the device inspecting unit.

9. The maintenance information managing apparatus according to claim 1, wherein the work information includes a time at which the device is attached to the device inspecting unit, and a time at which the device is removed from the device inspecting unit.

10. The maintenance information managing apparatus according to claim 9, wherein the work information further includes information on whether the device is inspected by the device inspecting unit or not.

11. The maintenance information managing apparatus according to claim 1, further comprising;
an antenna attached to the receiver; and
a portable receiving terminal adapted to be carried by a user,
wherein the receiver is connected to the component mounting machine, and determines whether the device needs to be inspected or not, and
when the receiver receives the identification information and determines that the device identified by the identification information does not need to be inspected, the receiver sends an alarm to the portable receiving terminal via the antenna.
